(19) United States
(12) Patent Application Publication
(10) Pub. No.: US 2025/0354505 A1
(43) Pub. Date: Nov. 20, 2025

(54) INTERNAL COMBUSTION ENGINE ARRANGED WITH THE CRANKSHAFT AT THE TOP AND CORRESPONDING CONTROL METHOD

(71) Applicant: FERRARI S.P.A., Modena (IT)

(72) Inventors: Massimo MEDDA, Modena (IT); Luca LAMBERTI, Modena (IT); Michele DI SACCO, Modena (IT)

(21) Appl. No.: 19/207,564

(22) Filed: May 14, 2025

(30) Foreign Application Priority Data
May 16, 2024 (IT) 102024000011170

(51) Int. Cl. F01M 1/16; F01M 1/02

(52) U.S. Cl. CPC F01M 1/16; F01M 1/02

(57) ABSTRACT

An internal combustion engine having: a plurality of cylinders, where respective pistons slide on the inside; a crank chamber arranged higher than the cylinders; a crankshaft, which is arranged in the crank chamber higher than the cylinders and is connected to the pistons; a lubricating system provided with an oil tank, with a lubricating pump, which draws from the oil tank, and with a series of lubricating devices, which receive oil from the lubricating pump and supply oil to moving components; and a control unit configured, when a command to turn off the internal combustion engine is received, to interrupt the supply of oil to the lubricating devices in advance with respect to the actual stopping of the rotation of the crankshaft.

### CROSS-REFERENCE TO RELATED APPLICATIONS

This patent application claims priority from Italian patent application no. 102024000011170 filed on May 16, 2024, the entire disclosure of which is incorporated herein by reference.

### TECHNICAL FIELD

The present invention relates to an internal combustion engine arranged with the crankshaft at the top and to a corresponding control method.

### PRIOR ART

In all known cars, the internal combustion engine is oriented so as to arrange in the upper part the cylinders inside which the pistons slide and to arrange in the lower part the crankshaft connected to the pistons by means of the connecting rods.

Documents EP4328432A1, U.S. Pat. Nos. 11,041,456B2, 2,198,141A, US2012118658A1, U.S. Pat. Nos. 6,536,382B1 and 2,306,554A describe an internal combustion engine with an inverted orientation, namely arranged with the crankshaft at the top and the cylinders at the bottom.

Patent application CH248925A describes a lubricating system for an internal combustion engine with reversed cylinders, wherein a first oil pump is provided which is actuated by a first electric motor, draws from the bottom of a sump of the internal combustion engine for supplying oil to a tank and is actuated for a short time interval after the internal combustion engine has been turned off, and a second oil pump is provided which is incorporated in a starting mechanism actuated by a second electric motor, draws oil from the tank for supplying oil to lubricating devices of the internal combustion engine, and is actuated, together with the starting mechanism, only upon the starting of the internal combustion engine when the internal combustion engine is dragged into movement by the starting mechanism. In this manner, the lubrication of the internal combustion engine during the starting is limited to the quantity of oil contained in the tank (i.e. to the quantity of oil drained from the sump by the action of the first oil pump when the internal combustion engine stops) and this lubrication is not renewed during the following starting attempts if the internal combustion engine does not start at the first attempt.

### DESCRIPTION OF THE INVENTION

The object of the present invention is to provide an internal combustion engine arranged with the crankshaft at the top and a corresponding control method which allow reducing the emission of pollutants (in particular, upon the starting of the internal combustion engine).

According to the present invention, an internal combustion engine arranged with the crankshaft at the top and a corresponding control method are provided, in accordance with what claimed by the appended claims.

The claims describe preferred embodiments of the present invention forming integral part of the present description.

### BRIEF DESCRIPTION OF THE DRAWINGS

The present invention will now be described with reference to the accompanying drawings, which illustrate a non-limiting example embodiment thereof, wherein:

FIG. 1 is a schematic view of an internal combustion engine arranged with the crankshaft at the top;

FIG. 2 is a perspective view of two camshafts of the internal combustion engine of FIG. 1; and

FIG. 3 is a partially schematic section view of the internal combustion engine of FIG. 1.

### PREFERRED EMBODIMENTS OF THE INVENTION

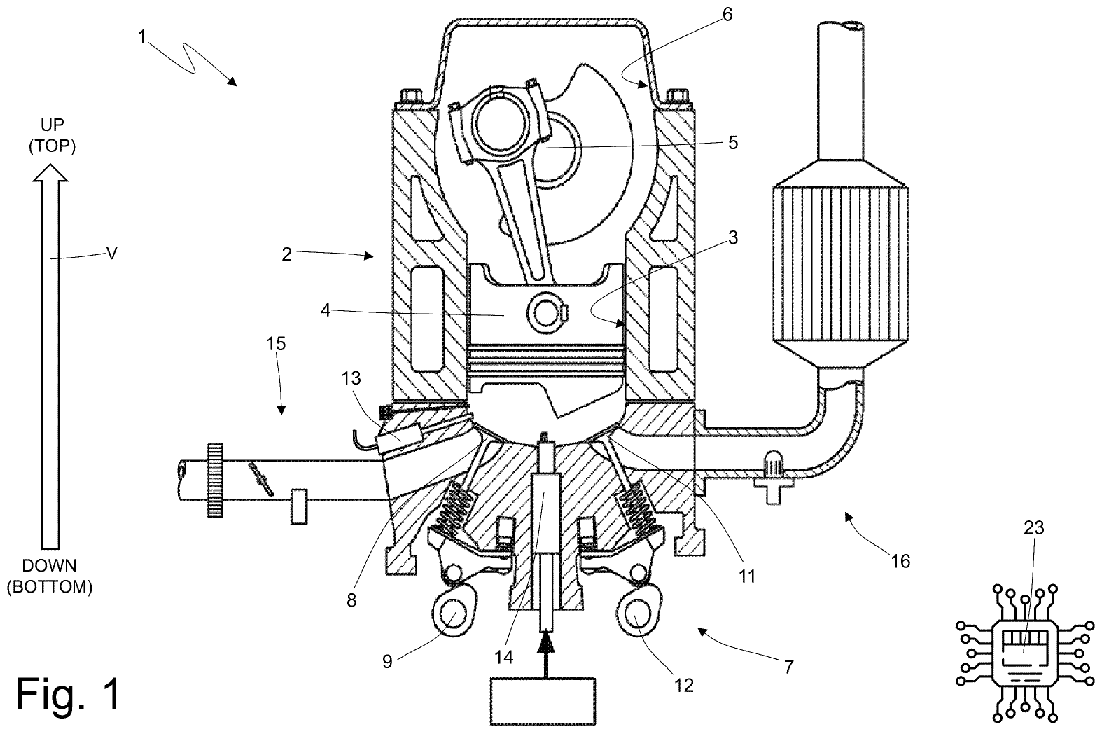

In FIG. 1, reference numeral 1 indicates, as a whole, an internal combustion engine which is preferably supplied with hydrogen.

According to what is illustrated in FIG. 1, the internal combustion engine 1 comprises a block 2 inside which a plurality of cylinders 3 (only one of which is illustrated in FIG. 1) is obtained. In the embodiment illustrated in the accompanying figures, six cylinders 3 arranged in line are provided, but obviously the number and the arrangement of the cylinders 3 could be different (for example the cylinders 3 could be four or eight and could have a “V” arrangement instead of being arranged in line).

Each cylinder 3 has a respective combustion chamber and a corresponding piston 4 mechanically connected to a crankshaft 5 (by means of a respective connecting rod) for transmitting to the crankshaft 5 the force generated by the combustion. In particular, in the block 2 there is a crank chamber 6 inside which the crankshaft 5 and the connecting rods connecting the crankshaft 5 to the pistons 4 are arranged.

The block 1 is coupled (connected) to a head 7 (or cylinder head) which constitutes the top of the cylinders 3 (namely the upper closure of the cylinders 3 with the so-called “flame plate”). In the case of an arrangement in line of the cylinders 3, one single head 7 is provided (as is illustrated in FIG. 1), whereas in the case of a “V” arrangement of the cylinders 3, two twin heads 7 for the two main bearings of cylinders 3 are provided. The assembly of the block 1 and of the head 7 constitutes the engine block of the internal combustion engine 1.

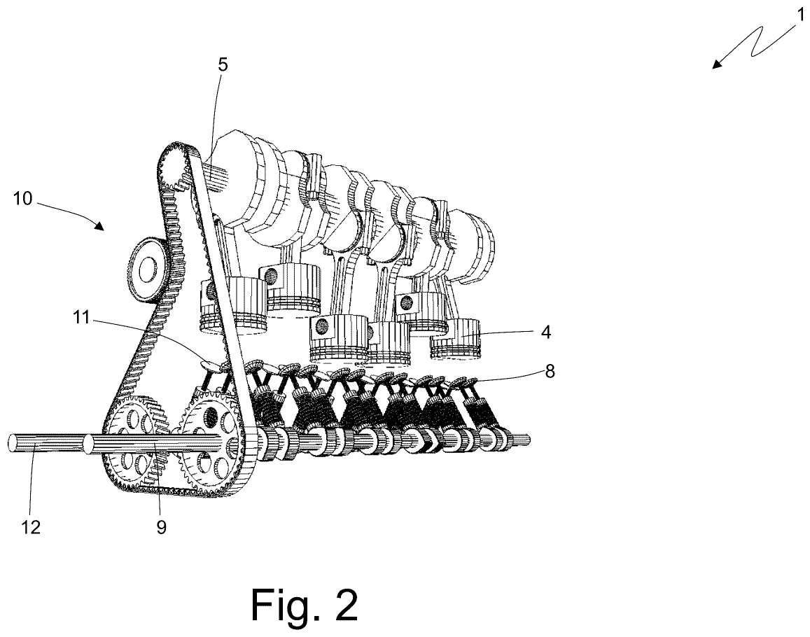

Each cylinder 3 comprises two intake valves 8 controlled by a camshaft 9 which receives the motion from the crankshaft 5 by means of a belt drive 10 (illustrated in FIG. 2); in alternative to the belt drive 10, a chain drive or a gear drive could be used. Furthermore, each cylinder 3 comprises two exhaust valves 11 controlled by a camshaft 12 which receives the motion from the crankshaft 5 by means of the belt drive 10 (illustrated in FIG. 2). The intake valves 8, the exhaust valves 11 and the corresponding control means (namely the return springs and the camshafts 9 and 12) are housed in the head 7.

Each cylinder 3 further comprises a (at least one) fuel injector 13 which cyclically injects fuel into the cylinder 3; FIG. 1 illustrates a direct injection of the fuel into the cylinder 3 but the injection of the fuel into the cylinder 3 could also be (partially or completely) indirect. Each cylinder 3 comprises a (at least one) spark plug 14 which is cyclically activated for triggering the ignition of the mixture of air (comburent) and fuel present in the combustion chamber at the end of the compression step.

According to what is illustrated in the accompanying figures, the internal combustion engine 1 is oriented vertically with the crankshaft 5 (housed in the crank chamber 6) arranged higher than the cylinders 3. In other words, the internal combustion engine 1 is arranged “upside down” with respect to the traditional arrangement which provides for the cylinders 3 to be at the top and the crankshaft 5 to be at the bottom. Consequently, the head 7 which constitutes the top of the cylinders 3 is arranged below the block 1 and represents the lowest part of the internal combustion engine 1. FIG. 1 highlights the vertical direction V and it is thus evident that the crank chamber 6 and the crankshaft 5 are above the cylinders 3 and the head 7 and therefore higher than the cylinders 3 and the head 7.

The internal combustion engine 1 comprises an intake system 15 which takes air from the external environment for conveying air into the cylinders 3 (the inlet of air into the cylinders 3 is adjusted by the intake valves 8). The internal combustion engine 1 comprises an exhaust system 16 which lets the exhaust gases coming from the cylinders 3 into the external environment.

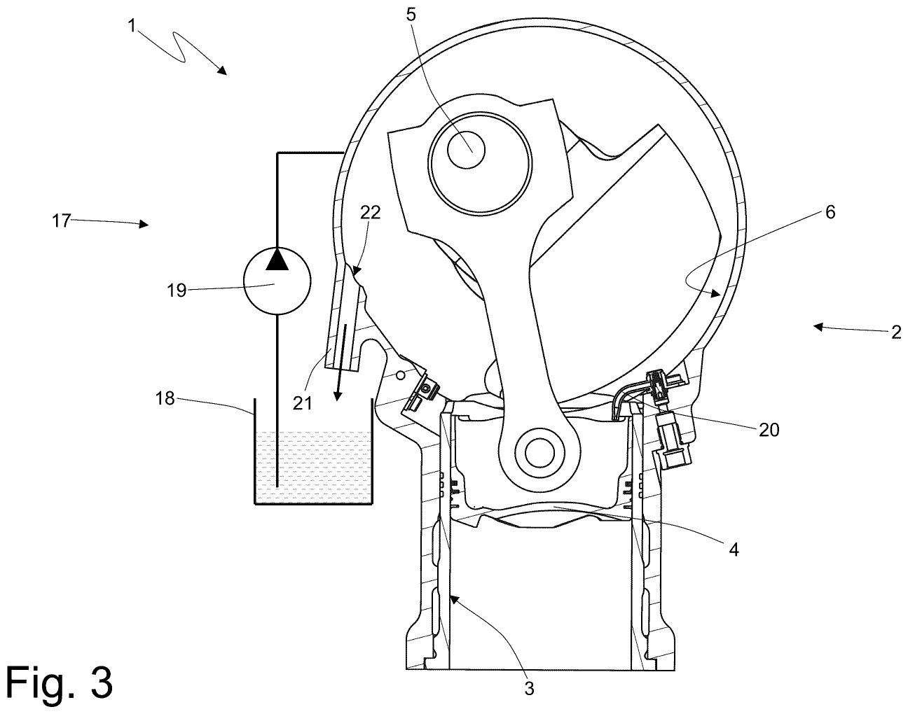

According to what is illustrated in FIG. 3, the internal combustion engine 1 comprises a lubricating system 17 provided with an oil tank 18 and with a lubricating pump 19 which draws from the oil tank 18 and supplies oil under pressure to a series of lubricating devices 20. In other words, the lubricating devices 20 receive oil under pressure from the lubricating pump 19 and supply oil under pressure to the moving components of the internal combustion engine 1. The lubricating devices 20 comprise, for each piston 4, piston jets which directly send oil under pressure towards the piston 4, main bearings (namely the lubricated bearings which support the crankshaft 5) and connecting rod bearings (namely the lubricated bearings which connect the crankshaft 5 to the connecting rods). The lubricating system 17 comprises a return duct 21 which originates from an opening 22 obtained through a wall of the crank chamber 6 and ends in the tank 18. In use, the rotation of the crankshaft 5 and the movement of the connecting rods cause a rotary movement of the oil in the crank chamber 6, which causes the oil to flow into the opening 22 of the return duct 21 by centrifugal force; in this manner, the oil in the crank chamber 6 progressively arrives in the return duct 21 which ends in the tank 18.

The internal combustion engine 1 comprises a control unit 23 (schematically illustrated in FIG. 1) which supervises the operation of the internal combustion engine 1.

The control unit 23 is configured, when a command to turn off the internal combustion engine 1 is received, to interrupt the supply of oil to the lubricating devices 20 in advance with respect to the actual stopping of the rotation of the crankshaft 5. Namely, the supply of oil to the lubricating devices 20 is interrupted before the actual stopping of the rotation of the crankshaft 5 and therefore the crankshaft 5 rotates for a short time interval without new lubrication; preferably, the supply of oil to the lubricating devices 20 is interrupted with an advance ranging from 0.5 to 2.5 seconds (and generally equal to approximately 1 second) with respect to the actual stopping of the rotation of the crankshaft 5.

According to a preferred embodiment, the lubricating pump 19 has an adjustable displacement and the actual displacement of the lubricating pump 19 is reduced to zero (or anyway reduced to very small values) so as to interrupt the supply of oil to the lubricating devices 20 (namely the delivery flow rate of the lubricating pump 19 is annulled). In alternative, a bypass duct is provided which is arranged downstream of the delivery of the lubricating pump 19 and ends in the tank 18 and is opened so as to interrupt the supply of oil to the lubricating devices 20.

By interrupting the supply of oil to the lubricating devices 20 before the actual stopping of the rotation of the crankshaft 5, it is possible to empty the crank chamber 6 of the oil since the oil present in the crank chamber 6 progressively comes out of the opening 22 without being replaced by new oil coming from the lubricating devices 20. Therefore, by interrupting the supply of oil to the lubricating devices 20 before the actual stopping of the rotation of the crankshaft 5, it is possible to leave the crank chamber 6 substantially devoid of oil when the internal combustion engine 1 is stopped. Actually, in the crank chamber some oil anyway remains when the internal combustion engine 1 is stopped, but the residual quantity of oil in the crank chamber 6 when the internal combustion engine 1 is stopped is a very small amount of the engine oil which is normally in the crank chamber 6 when the internal combustion engine 1 is operating.

Leaving little oil in the crank chamber 6 when the internal combustion engine 1 is stopped allows avoiding that by gravity a relevant quantity of oil descends downwards settling on the oil scraper rings of the pistons 4 and thus over time may leak (still by gravity) arriving inside the combustion chambers of the cylinders 3; in fact, the oil that leaks inside the combustion chambers is burned at the following: restart of the internal combustion engine 1 generating (in a totally undesired manner) an excess of pollutants at the moment of the restart.

It is important to observe that the time interval between the interruption of the supply of oil to the lubricating devices 20 and the actual stopping of the rotation of the crankshaft 5 has to be sufficiently long to allow emptying in a suitable manner the crank chamber 6 from the oil (namely the residual quantity of oil inside the crank chamber 6 has to be sufficiently reduced so as not to give place to significant leakages in the combustion chambers of the cylinders 3), but, at the same time, the time interval between the interruption of the supply of oil to the lubricating devices 20 and the actual stopping of the rotation of the crankshaft 5 must not be too long such to cause excessive mechanical wears in the rotary components that rotate with a greatly insufficient lubrication. Therefore, the duration of the time interval between the interruption of the supply of oil to the lubricating devices 20 and the actual stopping of the rotation of the crankshaft 5 is necessarily a compromise between the need to empty the crank chamber 6 of the oil and the need not to cause excessive mechanical wears in the rotary components.

According to a preferred embodiment, the control unit 23 is configured to cause the crankshaft 5 to rotate at a predetermined rotation speed (for example equal to 2,000 rpm) greater than the idling speed when the supply of oil to the lubricating devices 20 is interrupted; causing the crankshaft 5 to rotate sufficiently fast (namely faster than the idling speed), it is possible to empty the crank chamber 6 of the oil in a reduced time (in the order of 1 maximum 2 seconds) and thus limiting the mechanical wear in the rotary components.

According to a possible embodiment, when a command to turn off the internal combustion engine 1 is received, the crank chamber 6 is emptied of the oil with the modes described above only if the command to turn off the internal combustion engine 1 was generated by the driver of a vehicle in which the internal combustion engine 1 is installed (and it is thus predictable that the internal combustion engine 1 remains turned off for an also very long time interval which gives the necessary time to the oil present in the crank chamber 6 to leak by gravity into the combustion chambers of the cylinders 3); whereas, when the command to turn off the internal combustion engine 1 was generated by the control unit 23 (for example by effect of a “start & stop” strategy which turns off the internal combustion engine 1 for short periods) the crank chamber 6 is not emptied of the oil with the modes described above since the oil present in the crank chamber 6 does not anyway have the time to leak by gravity in the combustion chambers of the cylinders 3.

The embodiments described herein can be combined with one another.

The internal combustion engine 1 described above has numerous advantages.

Firstly, the internal combustion engine 1 described above does not have the generation of a high quantity of pollutants (essentially particulates) at the moment of the start due to an (undesired) excess of lubricating oil present in the combustion chambers of the cylinders 3.

Furthermore, the internal combustion engine 1 described above is easy and cost-effective to manufacture with respect to a known similar internal combustion engine 1 since the differences are substantially only at software level (namely it is sufficient to update the software of the control unit 23 for interrupting the supply of oil to the lubricating devices 20 in advance with respect to the actual stopping of the rotation of the crankshaft 5).

### LIST OF THE REFERENCE NUMERALS OF THE FIGURES

1 internal combustion engine
2 block
3 cylinders
4 pistons
5 crankshaft
6 crank chamber
7 head
8 intake valves
9 camshaft
10 belt drive
11 exhaust valves
12 camshaft
13 fuel injector
14 spark plug
15 intake system
16 exhaust system
17 lubricating system
18 tank
19 lubricating pump
20 lubricating devices
21 return duct
22 opening
23 control unit
V vertical direction

1. An internal combustion engine (1) comprising:
a plurality of cylinders (3), where respective pistons (4) slide on the inside;
a crank chamber (6) arranged higher than the cylinders (3);
a crankshaft (5), which is arranged in the crank chamber (6) higher than the cylinders (3) and is connected to the pistons (4);
a lubricating system (17) provided with an oil tank (18), with a lubricating pump (19), which draws from the oil tank (18), and with a series of lubricating devices (20), which receive oil from the lubricating pump (19) and supply oil to moving components; and
a control unit (23) configured, when a command to turn off the internal combustion engine (1) is received, to interrupt the supply of oil to the lubricating devices (20) in advance with respect to the actual stopping of the rotation of the crankshaft (5).

2. The internal combustion engine (1) according to claim 1, wherein the control unit (23) is configured to interrupt the supply of oil to the lubricating devices (20) with an advance ranging from 0.5 to 2.5 seconds and preferably equal to approximately 1 second with respect to the actual stopping of the rotation of the crankshaft (5).

3. The internal combustion engine (1) according to claim 1, wherein the lubricating system (17) comprises a return duct (21), which originates from an opening (22) obtained through a wall of the crank chamber (6) and ends in the tank (18).

4. The internal combustion engine (1) according to claim 3, wherein, in use, the rotation of the crankshaft (5) causes a rotary movement of the oil in the crank chamber (6), which causes the oil to flow into the opening (22) of the return duct (21) by centrifugal force.

5. The internal combustion engine (1) according to claim 1, wherein:
the lubricating pump (19) has an adjustable displacement; and
the control unit (23) is configured to minimize the actual displacement of the lubricating pump (19) so as to interrupt the supply of oil to the lubricating devices (20).

6. The internal combustion engine (1) according to claim 1, wherein the lubricating devices (20) comprise piston jets, which directly send oil under pressure towards the pistons (4), main bearings and connecting rod bearings.

7. The internal combustion engine (1) according to claim 1, wherein the control unit (23) is configured to cause the crankshaft (5) to rotate at a predetermined rotation speed, which is greater than an idling speed, when the supply of oil to the lubricating devices (20) is interrupted.

8. The internal combustion engine (1) according to claim 1, wherein the control unit (23) is configured, when the command to turn off the internal combustion engine (1) is received, to interrupt the supply of oil to the lubricating devices (20) in advance with respect to the actual stopping of the rotation of the crankshaft (5), only if the command to turn off the internal combustion engine (1) was generated by a driver.

9. The internal combustion engine (1) according to claim 1, wherein the control unit (23) is configured, when the command to turn off the internal combustion engine (1) is received, to not interrupt the supply of oil to the lubricating devices (20) in advance with respect to the actual stopping of the rotation of the crankshaft (5), if the command to turn off the internal combustion engine (1) was generated by the control unit (23).

10. A method to control an internal combustion engine (1) comprising:
a plurality of cylinders (3), where respective pistons (4) slide on the inside;
a crank chamber (6) arranged higher than the cylinders (3);
a crankshaft (5), which is arranged in the crank chamber (6) higher than the cylinders (3) and is connected to the pistons (4);
a lubricating system (17) provided with an oil tank (18), with a lubricating pump (19), which draws from the oil tank (18), and with a series of lubricating devices (20), which receive oil from the lubricating pump (19) and supply oil to moving components; and
a control unit (23);
the control method comprises the step, when a command to turn off the internal combustion engine (1) is received, of interrupting the supply of oil to the lubricating devices (20) in advance with respect to the actual stopping of the rotation of the crankshaft (5).
